(19) United States
(12) Patent Application Publication
(10) Pub. No.: US 2003/0178409 A1
(43) Pub. Date: Sep. 25, 2003

(54) Hand-guided machine having automatically regulated heating of the handles

(75) Inventor: Peter Kempf, Bad Oldesloe (DE)

Correspondence Address: Stephen P. Scuderi, Esq., McCormick, Paulding & Huber LLP, CityPlace II, 185 Asylum Street, Hartford, CT, 06103, US

(73) Assignee: DOLMAR GmbH, Hamburg (DE)

(21) Appl. No.: 10/371,034

(22) Filed: Feb. 20, 2003

(30) Foreign Application Priority Data
Mar. 21, 2002 (DE) 20204570.6

(51) Int. Cl. H05B 1/02

(52) U.S. Cl. 219/494; 219/204; 219/205

(57) ABSTRACT

In order to provide a hand-guided machine, which is partially or completely used at low ambient temperatures, with a heating arrangement of the handles, comprising an AC source, an analysis electronic system, at least one temperature sensor connected to the analysis electronic system and at least one electrical heating element supplied with power from the AC source, with which heating of handles of hand-guided machines is possible and which avoids the disadvantages of known handle heaters and particularly relieves the operator in his work activity as well as providing an ergonomically favorable working environment, so that work accidents and occupational illnesses are avoided, it is suggested that the output of the at least one electrical heating element be switched and regulated by an electronic component, controlled by the analysis electronic system, in the form of transistors, IGBTs, GTOs, thyristors, or TRIACs.

### FIELD OF THE INVENTION

The present invention relates to the field of hand-guided machines having any type of drive which is used at low ambient temperatures. The present invention preferably relates to hand-guided machines in which vibrations act on the handles during operation. The present invention relates to automatically regulated electrical heating of handles of the machines cited above according to the preamble of claim 1.

### BACKGROUND OF THE INVENTION

The heating of the handles of hand-guided machines fulfills the purpose of reducing the heat dissipation from the hands of the operator when the machines are used in cold surroundings. The heat dissipation from the operator's hands occurs through the heat transfer from the hands to the surrounding fluid, as well as via the contact with the handles when they assume the ambient temperature. The cooling of the hands interferes with the subjective sensitivity of the operator, so that his motor capabilities are restricted and the precision of his movements is reduced. In connection with the effect of vibrations of the machine on the hands of the operator via the handles, he may become subject to white finger disease. The occurrence and progress of the clinical picture may be promoted by the cooling of the hands.

Automatic feedback control circuits for regulating heating and cooling systems on the basis of a command variable are known. Such systems may operate mechanically, electrically, and electronically. The systems are disseminated as room thermostats or for temperature control of processes in process engineering.

Furthermore, heaters for handles of hand-guided machines, whose heat output may be controlled by an intervention of the operator, are known (example: German Utility Model 70 20 398). The known heaters operate, for example, through electric heating elements or through the targeted guiding of waste heat of the machine to the handles. A fluid which escapes from the machine at a high temperature, for example, may be used as a medium for transferring the waste heat, or a separate medium is heated by the machine via a heat exchanger and guided to the handles. The operator of the machine may control the heat output of the known handle heating systems by changing the setting of flow valves or electrical switches. In order to ensure rapid heating of the handles after the machine is put into operation and provide a sufficient output reserve for very low ambient temperatures under the freezing point, the known handle heating systems are frequently dimensioned generously in regard to the rated heating output, so that an output excess exists in most applications. An example of this is hand-guided chainsaws having an internal combustion engine as a drive source, in which the energy for the handle heating is taken from the engine.

Heating systems which switch heating elements on and off using a mechanical bimetallic switch attached to a temperature measurement point, through which a feedback control circuit is provided, are also known. Such heating systems are used for seat and handle heaters of motorcycles and snowmobiles as well as handle heaters and carburetor heaters of motorized chainsaws (see German Patent Application DE-A1-199 53 914 in this regard). Switching points, switching hysteresis, and control rate are fixed by the construction of the bimetallic strip.

Heating elements which are implemented as electric PTC resistors are also known for the applications cited above. PTC resistors increase their internal resistance with their operating temperature, so that the current flow is reduced and a regulatory effect occurs.

The known heaters of the handles of hand-guided machines have several disadvantages.

Thus, the actual heat output, as a function of the form of energy generation for the handle heating, is a function of the operating point of the machine for many machines. In the event an unfavorable operating point is selected, this may lead to damage to the heating device or to the handles through excess temperature due to malfunction or incorrect operation of a heater control. There is also the danger of injury to the operator in the form of a skin burn due to the excess temperature.

Since the heating control is performed manually by the operator for known heaters of the handles of hand-guided machines, the control elements have at least one mechanical or electrical component having wear. For the mechanical components, the wear predominantly occurs in the form of abrasion, and for electrical components, predominantly in the form of burn-up or embrittlement. The defects of the components caused by wear lead to interruption of operation and increase the operating costs due to the repair required after a specific period of use.

The necessity of controlling the handle heater by the operator ensures at least brief distraction of the operator from the actual work procedure. Even a brief interruption of work to handle the control element is within the realm of possibility. While the interruption of work only leads to worsening of work productivity and may be perceived as subjectively annoying by the operator under certain circumstances, the brief distraction from the work procedure may lead to worsening of the work result or even to a work accident during dangerous work procedures.

The known self-regulating handle heating systems also have disadvantages. A compromise between a large switching hysteresis and a high switching frequency is to be found when laying out bimetallic switches for a handle heater. A large switching hysteresis causes a large temperature oscillation in the handle during the regulation process. The temperature curve graphed over time assumes a pronounced sawtooth shape, which is undesirable for ergonomic reasons. The use of a bimetallic switch having a switching rate reduces the service life of the system in turn, since the switch wears more rapidly due to stronger contact burn-out as a consequence of the higher switching frequency and the earlier appearance of fatigue in the contact tongue material. In handles subject to oscillation, the danger of uncontrolled switching as a consequence of switching contact tongue acceleration caused by oscillation is a further disadvantage of handle heaters regulated by bimetallic switches.

PTC resistors are predominantly produced from ceramic materials, whose other material properties and restricted molding capabilities make their use for heating handles more difficult.

It is therefore the object of the present invention to provide heating of handles of hand-guided machines which avoids the disadvantages of known handle heaters and particularly relieves the operator in his work activity, as well as providing an ergonomically favorable operating environment, so that work accidents and occupational illnesses may be avoided. Furthermore, a long service life and low maintenance requirements are to be achieved.

### SUMMARY OF THE INVENTION

The object is achieved by the totality of the features of claim 1. The core of the invention is to provide an automatic feedback control circuit which always keeps the temperature of at least one handle in the predetermined and preselected range, independently of the ambient temperature, by querying the temperature value on at least one handle through an electronic system and using an automatic, largely wear-free actuator, which is independent of external influences.

A preferred embodiment of the present invention, which is provided with particularly favorable properties, is distinguished in that the handles are electrically heated by an alternating current, and an electronic switching circuit measures the heating element temperature and activates an electronic power element, which in turn chokes or releases the electrical power supply to the heating elements. For alternating current supply, thyristors and TRIACs are preferably used as electronic power elements. Furthermore, the use of a circuit made of IGBTs or GTOs as a power element is possible. The activation is preferably pulsed, the pulse width and the pulse count within a limited time period corresponding to the supply power of the heating element. Through a suitable design of the analysis electronic system, even complex algorithms and/or regulatory characteristics, particularly “fuzzy logic”, may be implemented. A heating element, the electronic power element, and the electronic switching circuit are preferably assembled with the temperature measurement point and housed in a handle.

In a preferred refinement of the present invention, the electronic switching circuit is provided with an adjustment unit, so that the operator of the hand-guided machine may change the setpoint for the handle temperature.

The present invention is described in the following on the basis of exemplary embodiments in connection with the figures.

### BRIEF DESCRIPTION OF THE DRAWINGS

FIG. 1a shows the circuit diagram of a preferred exemplary embodiment of the handle heater according to the present invention using AC voltage as the operating voltage as well as a TRIAC as a power element;

FIG. 1b shows the circuit diagram of a second preferred exemplary embodiment of the handle heater according to the present invention using AC voltage as the operating voltage and a combination of IGBTs as a power element; and

FIG. 2 shows the circuit diagram of a third preferred exemplary embodiment of a handle heater according to the present invention using DC voltage as an operating voltage.

### DETAILED DESCRIPTION OF THE PREFERRED EMBODIMENTS

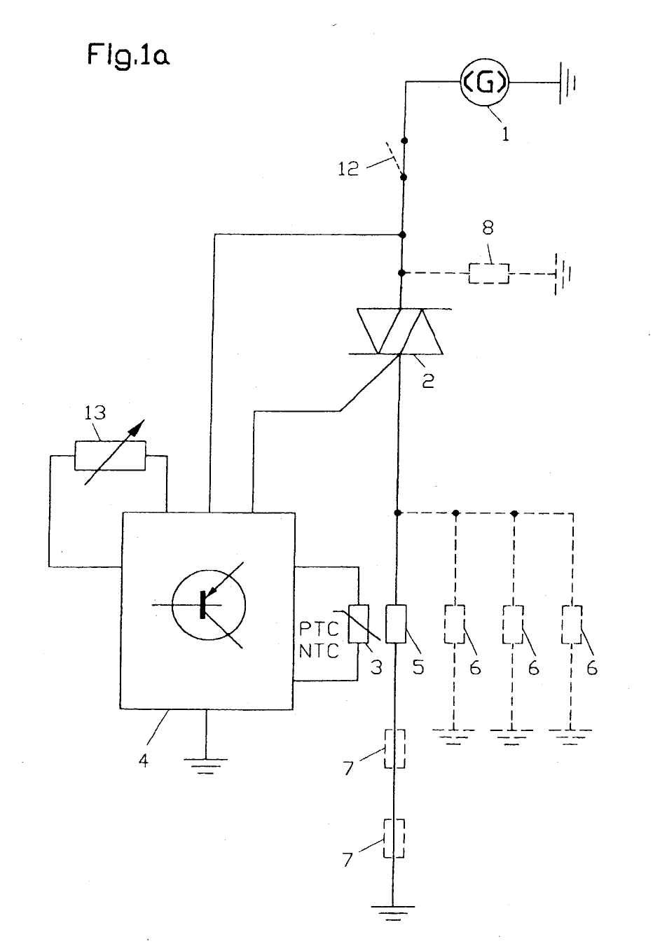

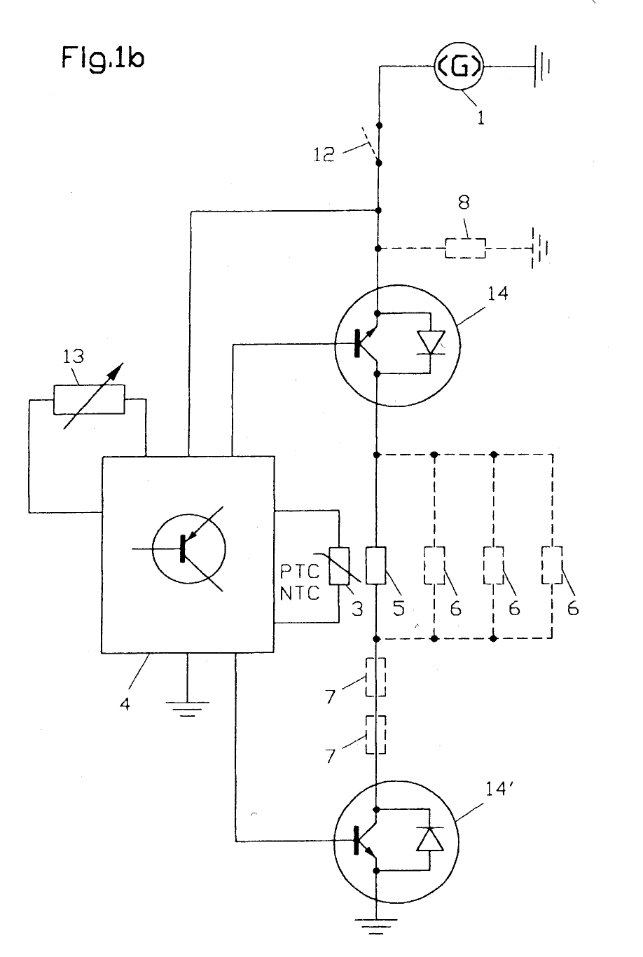

The circuit diagram of a first preferred exemplary embodiment of the present invention in the form of a handle heater using AC voltage as the operating voltage is illustrated in FIG. 1a. The handle heater comprises a generator 1, a TRIAC 2, a temperature sensor 3, an analysis electronic system 4, and an electrical heating element 5. The temperature sensor 3, which is preferably a PTC resistor, an NTC resistor, or a thermocouple, and the heating element 5 are positioned in direct proximity to the grip surface of the handle. Optionally, further heating elements 6, 7 may be connected in parallel (6) or in series (7). Multiple temperature sensors 3, which are assigned to individual handles, may also be connected to the analysis electronic system 4. As a further option, an overvoltage protector 8 may be provided. The overvoltage protector 8 may have the form of an LC circuit. However, it may also have the form of one or more suppressor diodes. Furthermore, the overvoltage protector 8 may have the form of a heating element with a low heat output, which is absorbed by the output regulator. The alternating current source and/or the generator 1 may optionally be electrically separated from the power consumers 5, 6, 7 of the heater arrangement using a switch 12. The analysis electronic system 4 may additionally have a stepped or continuous adjustment ability (13), which the operator of the hand-guided machine may use to adjust the achievable temperature of the heating elements 5, 6, 7.

The principle of the function of the automatically regulating handle heater from FIG. 1a may be described as follows:

An AC voltage is induced in the windings of generator 1 during operation of the handle heater. This AC voltage feeds the internal power supply of the analysis electronic system 4. Furthermore, at least one electrical heating element 5 is supplied. In the example shown, the analysis electronic system switches the TRIAC 2 through until the temperature sensor 3 has reached a temperature value corresponding to the setpoint temperature stored in the analysis electronic system 4. The power supply to the heating element 5 is then interrupted by switching off the TRIAC 2 and further heating is suppressed. To avoid voltage peaks through the impedance of the electrical components of the handle heater when the TRIAC 2 is shut off, a protective circuit (8) may optionally be a component of the electrical handle heater. After the temperature at the temperature sensor 3 has fallen below the setpoint through heat dissipation via the handle, the hands of the operator, and the surrounding fluid, the analysis electronic system 4 switches the TRIAC 2 through again, due to which the handle is heated again.

Analogously to FIG. 1a, a circuit diagram of a further preferred exemplary embodiment of the present invention is illustrated in FIG. 1b in the form of a handle heater using AC voltage as the operating voltage. In this case, however, the TRIAC 2 is replaced by two IGBTs 14, 14′. The IGBTs 14, 14′ may also be positioned one directly behind the other in the current flow diagram. The IGBTs 14, 14′ may also be combined into one component.

The principle of the function of the automatically regulating handle heater from FIG. 1b may be described as follows:

An AC voltage is induced in the windings of generator 1 during operation of the handle heater. This AC voltage feeds the internal power supply of the analysis electronic system 4. Furthermore, at least one electrical heating element 5 is supplied. In the example shown, the analysis electronic system switches the IGBTs 14, 14′ through until the temperature sensor 3 has reached a temperature value corresponding to the setpoint temperature stored in the analysis electronic system 4. The power supply to the heating element 5 is then interrupted by switching off the IGBTs 14, 14′ and further heating is suppressed. In this case, each IGBT switches the half wave of a polarity in the exemplary embodiment. After the temperature at the temperature sensor 3 has fallen below the setpoint through heat dissipation via the handle, the hands of the operator, and the surrounding fluid, the analysis electronic system 4 switches the IGBTs 14, 14′ through again, due to which the handle is heated again.

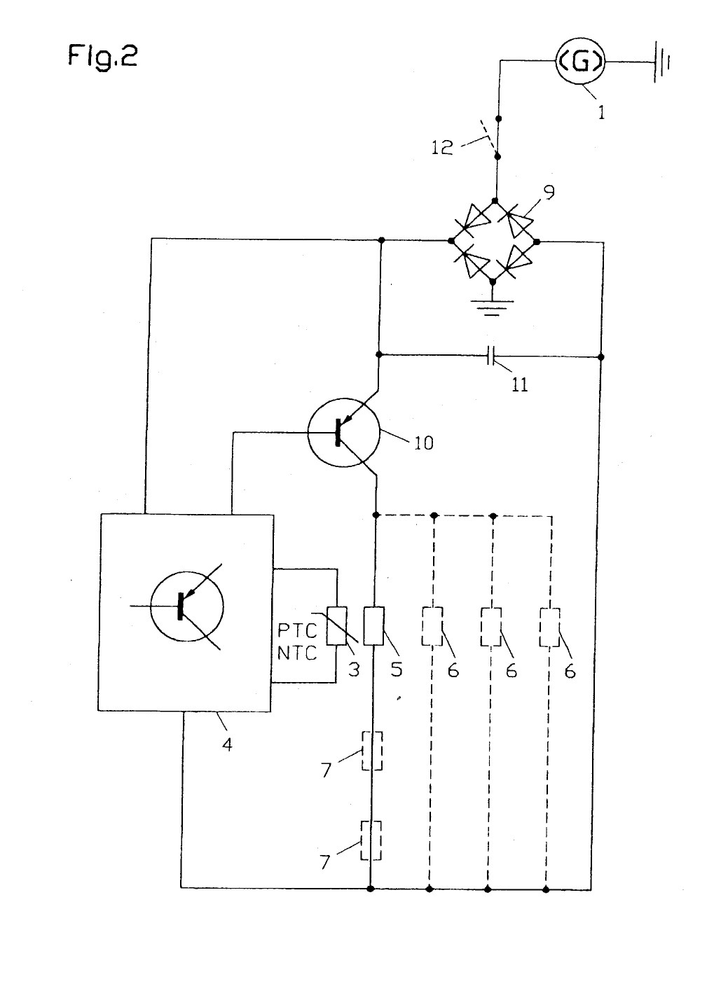

The circuit diagram of a third exemplary embodiment of the present invention in the form of a handle heater using DC voltage as the operating voltage is illustrated in FIG. 2. In this form, the handle heater comprises a generator 1, a rectifier 9, a transistor 10, a temperature sensor 3, an analysis electronic system 4, and an electrical heating element 5. The temperature sensor 3 and the heating element 5 are positioned in direct proximity to the grip surface of the handle. A capacitor 11 is optionally provided in the circuit to smooth the DC voltage.

The principle of the function of the automatically regulating handle heater from FIG. 2 may be described as follows:

A DC voltage is induced in the windings of generator 1 during operation of the handle heater. This DC voltage feeds the rectifier 9. The rectifier circuit produces the operating voltage for the analysis electronic system 4 and heating element 5. In the embodiment shown, the analysis electronic system 4 determines the temperature in the region of the handle with the aid of the temperature sensor 3 and varies the base voltage of the transistor 10 so that the temperature at the temperature sensor 3 is kept approximately constant along the setpoint, if the output of the current source (1) permits this.

### LIST OF REFERENCE NUMBERS

1 Generator

2 TRIAC

3 temperature sensor

4 analysis electronic system

5, 6, 7 heating elements

8 overvoltage protector

9 rectifier

10 transistor

11 capacitor

12 switch

13 adjustment ability

14, 14′ IGBTs

What is claimed is:

1. A hand-guided machine, which is partially or completely used at low ambient temperatures, having a heating arrangement of the handles, comprising an AC source (1), an analysis electronic system (4), at least one temperature sensor (3) connected to the analysis electronic system (4) and at least one electrical heating element (5, 6, 7) supplied with power from the AC source (1),
characterized in that
the output of at least one electrical heating element (5, 6, 7) is switched and regulated by an electronic component, controlled by the analysis electronic system (4), in the form of transistors (10), IGBTs (14, 14′), GTOs, thyristors, or TRIACs (2).

2. The hand-guided machine according to claim 1, characterized in that vibrations act on the handles due to the operation of the hand-guided machine.

3. The hand-guided machine according to claim 1, characterized in that the hand-guided machine is driven by an internal combustion engine and the AC source is a generator (1) driven by the machine.

4. The hand-guided machine according to claim 3, characterized in that the AC source (1) also provides the energy for electrical heating of the mixture formation and intake systems of the internal combustion engine.

5. The hand-guided machine according to claim 1, characterized in that the temperature sensor (3) is a PTC resistor, an NTC resistor, or a thermocouple.

6. The hand-guided machine according to claim 1, characterized in that the AC source (1) may be electrically separated from the power consumers (5, 6, 7) of the heating arrangement using a switch (12).

7. The hand-guided machine according to claim 1, characterized in that the electronic component (2, 10) which regulates the output, the analysis electronic system (4), at least one temperature sensor (3), and at least one heating element (5, 6, 7) are assembled in a handle of the hand-guided machine.

8. The hand-guided machine according to claim 7, characterized in that the electronic component (2, 10) which regulates the output, the analysis electronic system (4), and at least one temperature sensor (3) are housed on the carrier of the heating element (5, 6, 7) and the component (2, 10) which regulates the output dissipates its leakage output in the form of waste heat via the carrier.

9. The hand-guided machine according to claim 1, characterized in that the heating arrangement has an overvoltage protector (8) in the form of an LC circuit.

10. The hand-guided machine according to claim 1, characterized in that the heating arrangement has an overvoltage protector (8) in the form of one or more suppressor diodes.

11. The hand-guided machine according to claim 1, characterized in that the heating arrangement has an overvoltage protector (8) in the form of a heating element having a low heating output which is absorbed by the output regulator.

12. The hand-guided machine according to claim 1, characterized in that multiple heating elements (5, 7) are connected in series.

13. The hand-guided machine according to claim 1, characterized in that multiple heating elements (5, 6) are connected in parallel.

14. The hand-guided machine according to one of claims 1 to 13, characterized in that multiple temperature sensors (3), which are assigned to individual handles, are connected to the analysis electronic system (4).

15. The hand-guided machine according to claim 1, characterized in that the analysis electronic system (4) has a stepped or continuous adjustment ability (13), which the operator of the hand-guided machine may use to adjust the achievable temperature of the heating elements (5, 6, 7).

16. The hand-guided machine according to claim 1, characterized in that the analysis electronic system (4) controls and/or may process complex algorithms, particularly “fuzzy logic”.
